(19) United States
(12) Patent Application Publication
(10) Pub. No.: US 2018/0241973 A1
(43) Pub. Date: Aug. 23, 2018

(54) VIDEO AND AUDIO RECORDING SYSTEM AND METHOD

(71) Applicant: Janet Newell, Radcliff, KY (US)

(72) Inventor: Janet Newell, Radcliff, KY (US)

(21) Appl. No.: 15/901,332

(22) Filed: Feb. 21, 2018

Related U.S. Application Data
(60) Provisional application No. 62/461,775, filed on Feb. 21, 2017.

(51) Int. Cl. H04N 7/18; H04N 5/77; G08B 21/02

(52) U.S. Cl. CPC H04N 7/188; H04N 7/185; H04N 5/2252; G08B 21/02; H04N 5/772

(57) ABSTRACT

A video and audio recording system including a camera assembly, mobile application operable upon an electronic device and rechargeable and replaceable power source. Camera assembly includes video module, audio module, housing, memory storage, and a wireless communication module. The camera assembly includes global positioning system tracking and initiates recording based upon a specified event. The system further includes a speaker such that a user may communicate verbally with the third party. Included in the system is a panic-button which induces the system to provide an alert to a law enforcement agency. Also, the system is configured to commence recording based upon a visual identification of a weapon, visual identification of an emergency, and/or a visual identification of a criminal activity.

### CROSS-REFERENCE TO RELATED APPLICATION(S)

The present application is related to and claims priority to U.S. Provisional Patent Application No. 62/461,775 filed Feb. 21, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of motion video signal processing for recording or reproducing of existing art and more specifically relates to digital recording and reproducing.

### RELATED ART

Surveillance is the monitoring of the behavior, activities, or information, usually of people, for the purpose influencing, managing, directing, or protecting them. This can include observation from a distance by means of electronic equipment or interception of electronically transmitted information (such as Internet traffic or phone calls); and it can include simple, no- or relatively low-technology methods such as human intelligence agents and postal interception.

Most video and audio surveillance systems are stationary; for example, home surveillance systems or vehicle dash cams are generally mounted semi-permanently in key locations. Inevitably, surveillance is limited by the number of cameras in an area, making it impossible to continuously track an individual. Such systems are also not useful in providing a user security when traveling away from the monitored location. Additionally, traditional surveillance systems are expensive and difficult to install, and may require additional infrastructure to record and display footage taken. A suitable solution is desired.

U.S. Pub. No. 2016/0182850 to Patrick J. Thompson relates to a body camera. The described body camera includes a body camera, a method of operating a body camera, a system for a body camera, and methods and systems for configuring a body camera. The body camera may include a digital camera configured to capture video. The body camera may also include one or more sensors for sensing data about the environment experienced by the body camera. The body camera may also include a global positioning system (GPS) receiver. The body camera may also include a transceiver for streaming video and sensor data. The body camera may further include local storage to buffer and store captured audio, video, GPS, and sensor data.

### SUMMARY OF THE INVENTION

In view of the foregoing disadvantages inherent in the known audio and video recording are art, the present disclosure provides a novel video and audio recording system and method. The general purpose of the present disclosure, which will be described subsequently in greater detail, is to provide an effective and efficient video and audio recording system and method.

A video and audio recording system is disclosed herein. The video and audio recording system includes a camera assembly, a mobile application operable upon an electronic device, and a rechargeable and replaceable power source. The camera assembly includes a video module, an audio module, a housing, a memory storage, and a wireless communication module. Also, the wireless communications module is configured to wirelessly communicate with the mobile application and the housing is removably affixable to a surface.

The camera assembly includes global positioning system tracking and initiates recording based upon a specified event. Further, the camera assembly includes facial recognition software and voice recognition software. Additionally, the camera assembly includes the capability to communicate with the mobile application via a wireless fidelity connection, and also can communicate with the mobile application via a short-range radio protocol connection as well as the capability to communicate with a third party. The system further includes a speaker such that a user may communicate verbally with the third party.

Included in the system is a panic-button which induces the system to provide an alert to a law enforcement agency. Also, the system is configured to commence recording based upon a visual identification of a weapon, visual identification of an emergency, and/or a visual identification of a criminal activity.

According to another embodiment, a method of use for the video and audio recording system is also disclosed herein. The method includes a first step; providing a video and audio recording system; a second step, affixing the video and audio recording system to a surface; a third step, commencing recording of simultaneous video and audio event; a fourth step, ceasing recording of a simultaneous video and audio event; a fifth step, alerting a third party of the video and audio event; and a sixth step, transmitting the recording of said video and audio event to a third party. Note that all steps may not be required in all instances or uses.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a video and audio recording system and method, constructed and operative according to the teachings of the present disclosure.

FIG. 1 is a perspective view of the video and audio recording system during an ‘in-use’ condition, according to an embodiment of the disclosure.

FIG. 2 is a diagram of the video and audio recording system of FIG. 1, according to an embodiment of the present disclosure.

FIG. 3 shows screenshots of the mobile application of the video and audio recording system of FIG. 1, according to an embodiment of the present disclosure.

FIG. 4 is a perspective view of the video and audio recording system of FIG. 1, according to an embodiment of the present disclosure.

FIG. 5 is a flow diagram illustrating a method of using the video and audio recording system of FIGS. 1-4, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a digital recording and reproducing art and more particularly to a video and audio recording system and method as used to improve the ability for a user to record events and provide alerts of emergencies and/or crimes to a third party.

Generally, the video and audio recording system may include a wearable, ornamental accessory containing a camera, a microphone, a tracking device, a transmitting device, and a mobile device application. The accessory may be in wireless communication with the mobile device, allowing a user to control the functions of the accessory using the mobile device application.

The system may comprise an eye. The system may be worn on the front of a shirt or at another location on a wearer's person or mounted to another location (e.g., rear-view mirror of a vehicle). The system records audio and visual information which may be transmitted by the system for viewing in real time by a third party or recorded for later viewing. Additionally, the system may transmit a location and recordings to a third party.

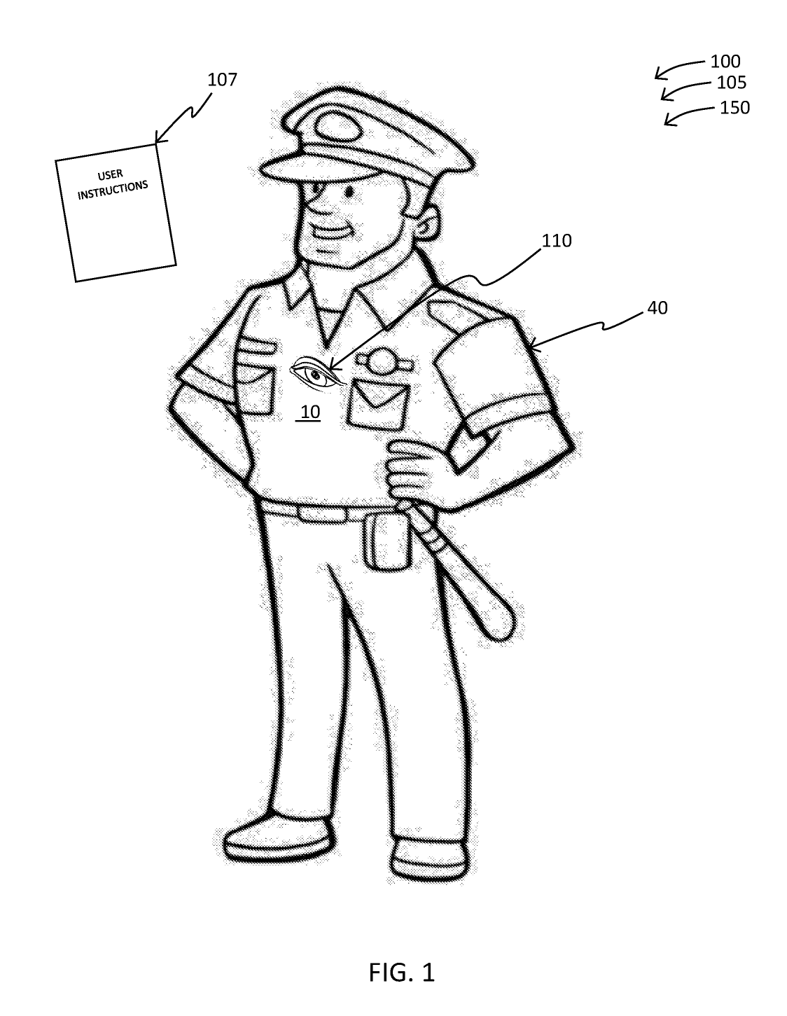

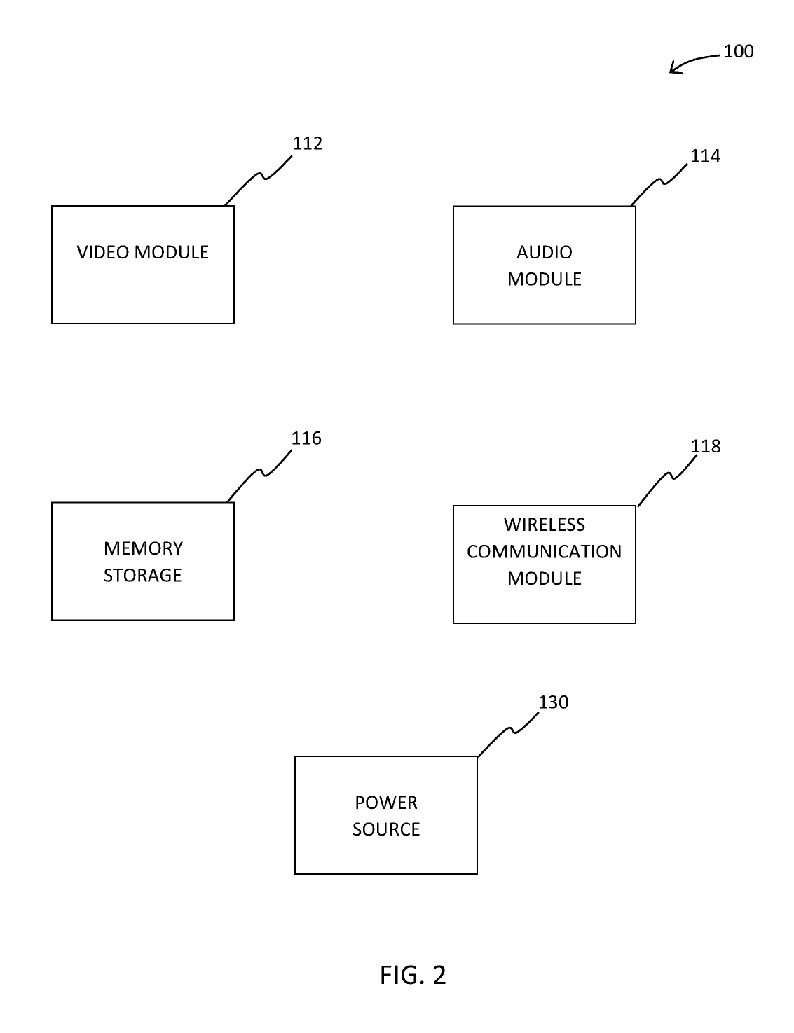

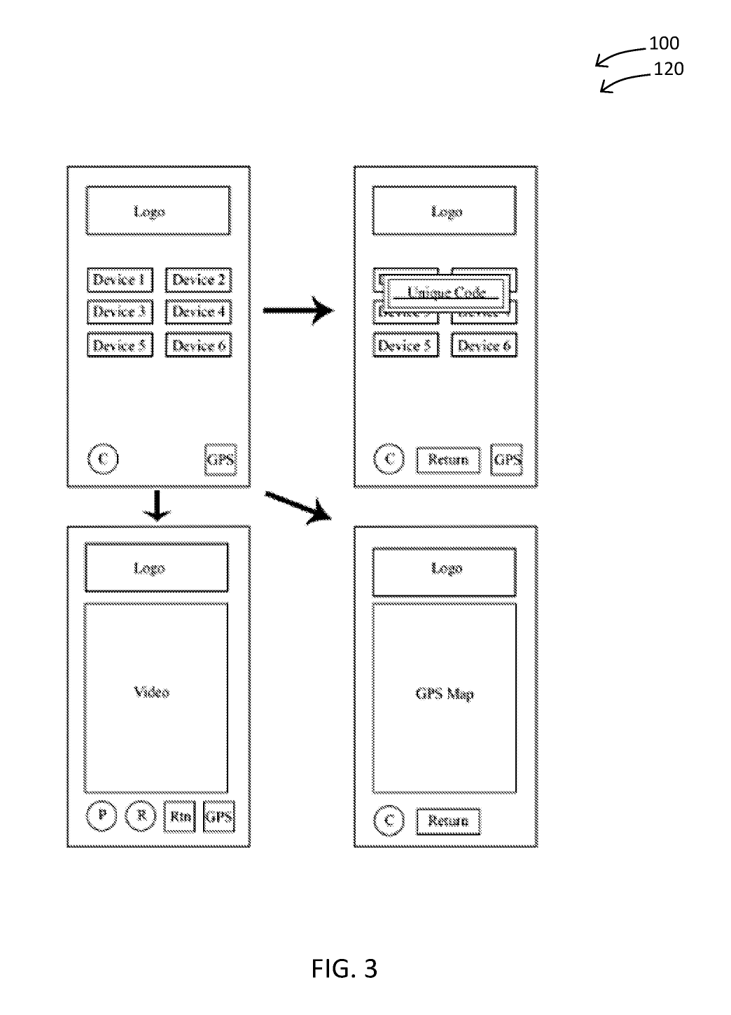

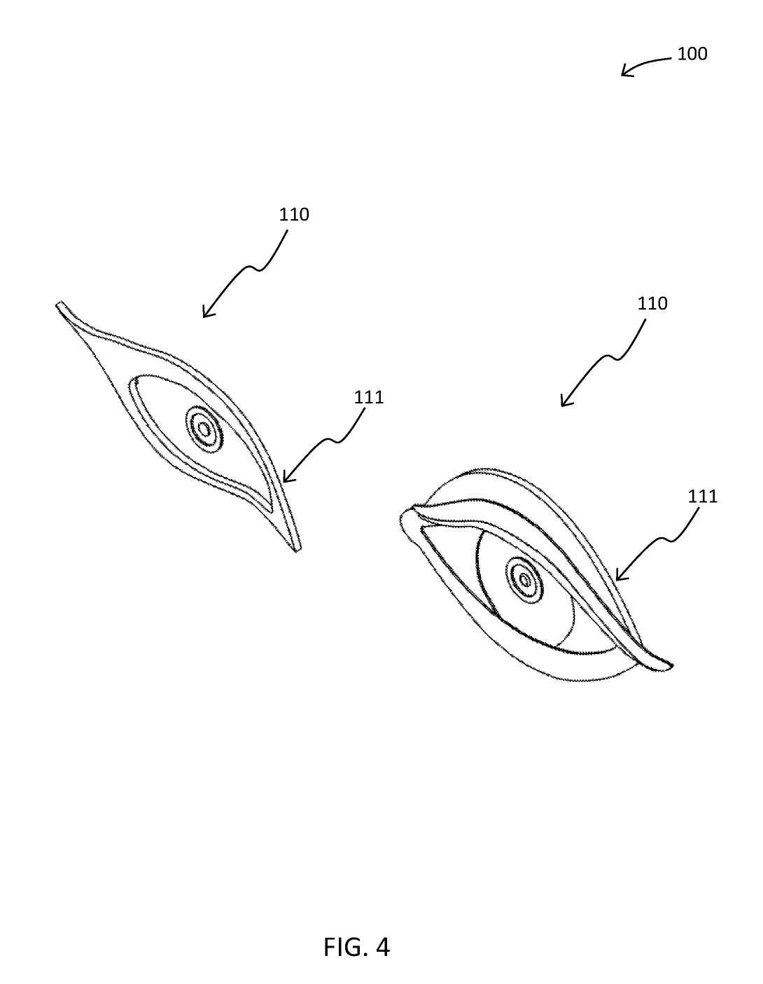

Referring now more specifically to the drawings by numerals of reference, there is shown in FIGS. 1-4, various views of a video and audio recording system 100.

FIG. 1 shows a video and audio recording system 100 during an ‘in-use’ condition 50, according to an embodiment of the present disclosure. As shown in FIGS. 1-4, video and audio recording system 100 may be beneficial for use by user 40 to record audio and video data for emergency and security purposes while providing an aesthetically pleasing device. As illustrated, the video and audio recording system 100 may include camera assembly 110, mobile application 120, and rechargeable and replaceable power source (not shown). Camera assembly 110 may include video module 112, audio module 114, housing 111, memory storage 116, and wireless communication module 118. Wireless communications module 118 may be configured to wirelessly communicate with mobile application 120. Housing 111 may be removably affixable to surface 10.

The affixation of housing 111 may include multiple means for fastening (e.g., hook-and-loop fastener, clips, buttons, adhesives, double-sided tape, etc.). Upon reading this specification, it should be appreciated that, under appropriate circumstances, considering such issues as user preferences, design preference, structural requirements, marketing preferences, cost, available materials, technological advances, etc., other mounted video camera arrangements may be sufficient. Also surface 10 may vary depending upon user 40 preferences (e.g., rear-view mirror of a vehicle, a garment of user, a wall, etc.). Further, housing 111 may include one of many shapes and sizes (e.g., eye-shaped, round, rectangular, triangular, etc.) depending upon user 40 preferences and specific applications. Housing 111 may resemble an article of ornamental jewelry such that system 100 may not be noticeable to an outside person.

Camera assembly 110 may include global positioning system tracking such that system 100 may be located remotely. Also, camera assembly 110 may include facial recognition software and may also include voice recognition software. Recording of audio and visual data may be commenced upon a wide variety of events. As such, system 100 may be configured to commence recording based upon a visual identification of a weapon (e.g., gun, knife, blunt-force weapon, explosive, incendiary device, etc.), to commence recording based upon a visual identification of an emergency, and/or upon a visual identification of a criminal activity.

Camera assembly 110 may additionally include communications with mobile application 120 via a wireless fidelity (“WIFI”) connection and/or a short-range radio protocol connection (e.g., “BLUETOOTH”). Also, camera assembly 110 may include the capability to communicate with a third party, where the third party may include, but not be limited to a law enforcement agency. As such, system 100 may further include a speaker and microphone such that user 40 may communicate verbally with the third party.

According to one embodiment, the video and audio recording system 100 may be arranged as a kit 105. In particular, the video and audio recording system 100 may further include a set of instructions 107. The instructions 107 may detail functional relationships in relation to the structure of the video and audio recording system 100 such that the video and audio recording system 100 can be used, maintained, or the like, in a preferred manner. Those with ordinary skill in the art will now appreciate that upon reading this specification and by their understanding the art of digital video recording as described herein, methods of use will be understood by those knowledgeable in such art.

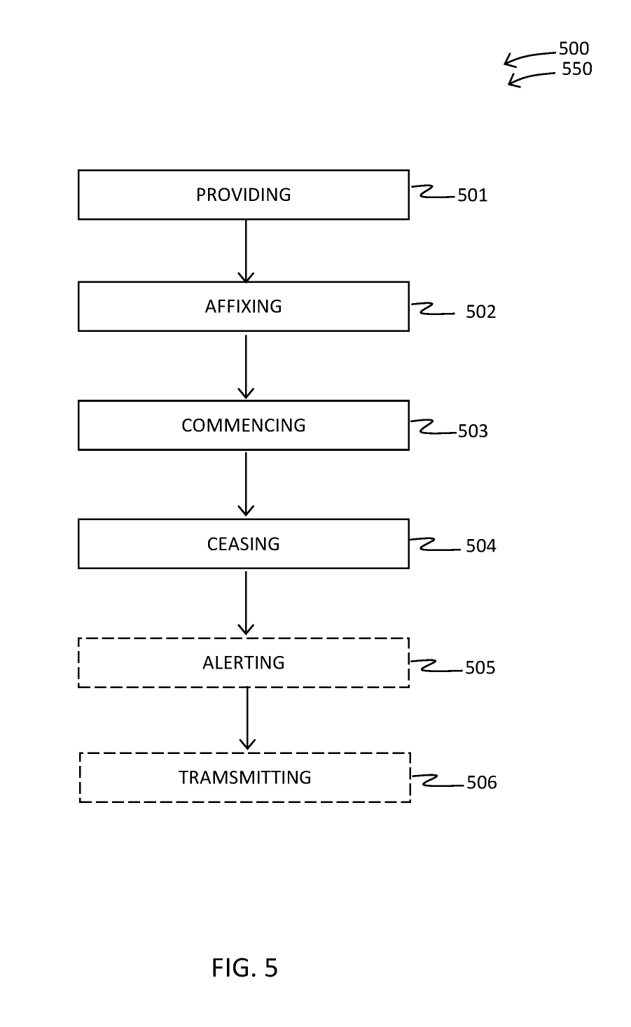

FIG. 5 is a flow diagram illustrating a method of using a video and audio recording system 500, according to an embodiment of the present disclosure. In particular, the method for method of using a video and audio recording system 500 may include one or more components or features of the video and audio recording system 100 as described above. As illustrated method of using a video and audio recording system 500 may include the steps of: step one 501, providing a video and audio recording system 100; step two 502, affixing video and audio recording system 100 to surface 10; step three 503, commencing recording of a simultaneous video and audio event; step four 504, ceasing recording of the simultaneous video and audio event; step five 505, alerting a third party of the video and audio event; and step six 506, transmitting the recording of the video and audio event to a third party.

It should be noted that step five 505 and step six 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of using a video and audio recording systems (NOTE: e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A video and audio recording system, the system comprising:
a camera assembly, said camera assembly including a video module, an audio module, a housing, a memory storage, and a wireless communication module;
a mobile application operable upon an electronic device;
a rechargeable and replaceable power source;
wherein said wireless communications module is configured to wirelessly communicate with said mobile application; and
wherein said housing is removably affixable to a surface.

2. The system of claim 1, wherein said surface includes clothing of a user.

3. The system of claim 1, wherein said surface includes a mirror of a vehicle.

4. The system of claim 1, wherein said camera assembly includes global positioning system tracking.

5. The system of claim 1, wherein said camera assembly initiates recording based upon a specified event.

6. The system of claim 1, wherein said camera assembly includes facial recognition software.

7. The system of claim 1, wherein said camera assembly includes voice recognition software.

8. The system of claim 1, wherein said camera assembly communicates with said mobile application via a wireless fidelity connection.

9. The system of claim 1, wherein said camera assembly communicates with said mobile application via a short-range radio protocol connection.

10. The system of claim 1, wherein said camera assembly includes the capability to communicate with a third party.

11. The system of claim 1, wherein said system includes a panic-button which induces said system to provide an alert to a law enforcement agency.

12. The system of claim 1, wherein said housing resembles an article of ornamental jewelry.

13. The system of claim 1, wherein said system is configured to commence recording based upon a visual identification of a weapon.

14. The system of claim 1, wherein said system is configured to commence recording based upon a visual identification of an emergency.

15. The system of claim 1, wherein said system is configured to commence recording based upon a visual identification of a criminal activity.

16. The system of claim 1, wherein said system further includes a speaker such that a user may communicate verbally with a third party.

17. A video and audio recording system, the system comprising:
a camera assembly, said camera assembly including a video module, an audio module, a housing, a memory storage, and a wireless communication module;
a mobile application operable upon an electronic device;
a rechargeable and replaceable power source;
wherein said wireless communications module is configured to wirelessly communicate with said mobile application;
wherein said housing is removably affixable to a surface;
wherein said camera assembly includes global positioning system tracking;
wherein said camera assembly initiates recording based upon a specified event;
wherein said camera assembly includes facial recognition software;
wherein said camera assembly includes voice recognition software;
wherein said camera assembly communicates with said mobile application via a wireless fidelity connection;
wherein said camera assembly communicates with said mobile application via a short-range radio protocol connection;
wherein said camera assembly includes the capability to communicate with a third party;
wherein said system includes a panic-button which induces said system to provide at least one alert to at least one law enforcement agency;
wherein said system is configured to commence recording based upon a visual identification of a weapon;
wherein said system is configured to commence recording based upon a visual identification of an emergency;
wherein said system is configured to commence recording based upon a visual identification of a criminal activity; and
said system further includes a speaker such that a user may communicate verbally with a third party.

18. The system of claim 17, further comprising set of instructions; and
wherein the system is arranged as a kit.

19. A method of using a video and audio recording system the method comprising the steps of:
providing a video and audio recording system;
affixing said video and audio recording system to a surface;
commencing recording of simultaneous video and audio event; and
ceasing recording of a simultaneous video and audio event.

20. The method of claim 19, further comprising the steps of:
alerting a third party of said video and audio event; and
transmitting said recording of said video and audio event to a third party.
